(19) United States
(12) Patent Application Publication
(10) Pub. No.: US 2005/0282481 A1
(43) Pub. Date: Dec. 22, 2005

(54) Shellfish opener

(76) Inventor: Samuel Banke, Highland Mills, NY (US)

Correspondence Address: Stanley J. Yavner;Suite 203, 120 North Main Street, New City, NY, 10956, US

(21) Appl. No.: 10/861,136

(22) Filed: Jun. 7, 2004

(51) Int. Cl. A22C 29/02

(52) U.S. Cl. 452/6

(57) ABSTRACT

A manually actuated clam opener is disclosed as having a holding arm and a knife arm in a scissor-like configuration, pivotally interconnected at the base of the knife arm, and at the midpoint of the holding arm. A ratchet and pawl connects the knife arm to a a first squeeze handle, the second squeeze handle being formed by the lower half of the holding arm. The purpose of the ratchet and pawl, prior to use, to hold the upper or operating part of the device (knife arm and holding arm) in a wide open position, the holding arm opposed to the knife arm. By repeatedly squeezing the first and second handle arms, the pawl moves in a manner to first insert the knife through the back or hinge point of the clam, and then to further insert the knife to cut the lip of the clam, which holds the shells together at the rounded portion of the clam shells.

### FIELD OF THE INVENTION

This invention relates primarily to a device for opening shellfish, and particularly for opening clams or oysters.

### BACKGROUND OF THE INVENTION

Various tools and devices have been proposed in the art for separating the shells of a shellfish such as a claum or an oyster. Indeed, many such devices have served as a cracking tool wherein one or both shells of the clam or oyster are cracked, thereby leaving remnants of the cracked shell in the meat of the clam or oyster. Such cracking devices have also taken the form of hammers such as those commonly used with crabs. All of such devices for cracking are less than satisfactory in that, at the very least, they cause soiling the clothing of the user; and at the other extreme since usually a shellfish is held by the user with his or her other hand, cutting and bruising of the user can be caused. Of course, the most extreme consequence of using such tools or devices for cracking open the shellfish relates to the residue of shell going into the meat of the shellfish.

Another class or device of tool for separating the shells of shellfish relates to a scissors-like or plier-like device, which also acts in many cases to crack the shell. Additionally, these devices also serve to damage the meat of the shellfish, especially since their use involves a rotating action for part of the periphery of the shellfish.

Still further, a clam opener is shown in the patent issued to Waechter, U.S. Pat. No. 3,706,114, wherein a scissor-like device has at its operating end a knife and a spoon, separable and closable by the scissors action. Waechter suggests the use of his device by squeezing the handles so that the knife arm inserts through the lip of the circular portion of the clam, and thereby wedges between the shells to eventually break the hinge of the clam resting in the spoon. Waechter further recommends the use of a hinge in order to return the handles to the open position upon completion of the crack. Unfortunately, the Waechter device usually requires manual final separation of the clam shells in order to break the hinge of the clam and use or eat the meat of the shellfish. Furthermore, the Waechter tool first inserts the knife through the lip of the clam, as described above, which sometimes is irregular enough or unstable enough to prevent easy insertion.

### OBJECTS AND SUMMARY OF THE INVENTION

Accordingly, a primary object of the present invention is to provide a shellfish opener device which separates the clam (or oyster) shells, which less risk of cracking the shells during the opening process.

A further and more particular object of the present invention is to provide a scissor-like device for opening the clam at the hinge point, which is at the back of the clam, wherein the knife of the device is more easily inserted, and less likely to cause rotation of the clam during the opening process

A still further object of the present invention is to provide a scissor-like device wherein the knife arm is joined to a first squeeze handle by means of a ratchet and pawl, and the holding arm is unitary with the second squeeze handle thereof, all to enable a controlled and yet forceful insertion of the knife of the knife arm in order to accomplish the opening of the clam in a more efficacious manner.

These and other objects of the present invention are provided by a scissor-like device which features a first knife arm, comprising a knife, at the base of which is defined a ratchet wheel having a plurality of teeth. Also, the base of the knife defines an opening for a rivet to hold a separation limiting pair of connecting bars, joined together also by a rivet, with the other connecting bar also being riveted to the approximate center of the first squeeze handle. The holding arm is for positioning the rounded front of the clam. The pawl is rotatably riveted above where one of the connecting bars is riveted. Therefore, in operation, the first and second squeeze handles are manually separated, so that the pawl inserts between teeth on the ratchet wheel, the teeth to which the pawl inserts is usually near one end of the row of teeth on the ratchet wheel. At that point, the clam is inserted, with the hinge point facing the knife, and the rounded front of the clam resting in a groove defined by the holding arm of the device. The squeeze handles are then repeatedly pressed together, which moves the pawl, tooth by tooth, to the second end of the row of teeth on the ratchet wheel, thereby inserting the knife through the hinge point at the back of the clam, and then between the clam shells all the way to the rounded front. Removal of the top shell is usually automatic, but in any event, one or both shells of the clam are completely removed by again spreading the squeeze handles to remove the knife from the shell and then the shell or shells from the groove of the holding arm.

### BRIEF DESCRIPTION OF THE DRAWINGS

Other objects, features and advantages of the present invention are provided in the following detailed description, of a preferred, but nonetheless illustrative, embodiment of the present invention, with reference to the accompanying drawings, wherein:

FIG. 1 is a plan view of a shellfish opener device according to the present invention, showing the scissor-like structure, with a ratchet wheel attached at the base of the knife arm and the pawl for operating therewith, all in a position for mounting of the clam by the spreading of the squeeze handles thereof;

FIG. 2 shows the device as the rotatable pawl is about to insert at one end of the row of teeth of the ratchet wheel and the clam is ready for full insertion to the groove defined by the inner edge of the holding arm, with the back or hinge point side of the clam facing the knife arm;

FIG. 3 is a sectional view, taken along the line of 3-3 of FIG. 2, and showing particularly the groove of the holding arm and the knife arm ready for insertion at the hinge point of the clam;

FIG. 4 shows the device of FIGS. 1 and 2, with the knife insertion in progress, the spread position of the squeeze handles in ghost lines and the repetitive squeezing of the squeeze handles also in progress; and the pawl, spring-mounted, moving to the other end of the row of teeth on the ratchet wheel;

FIG. 5 shows the knife arm fully inserted through the clam and into the bottomless groove of the holding arm; and

FIG. 6 is a sectional view, taken along the line 6-6 of FIG. 5, and showing the completion of the operation briefly described for FIG. 5 above.

### DETAILED DESCRIPTION OF THE PREFERRED EMBODIMENT

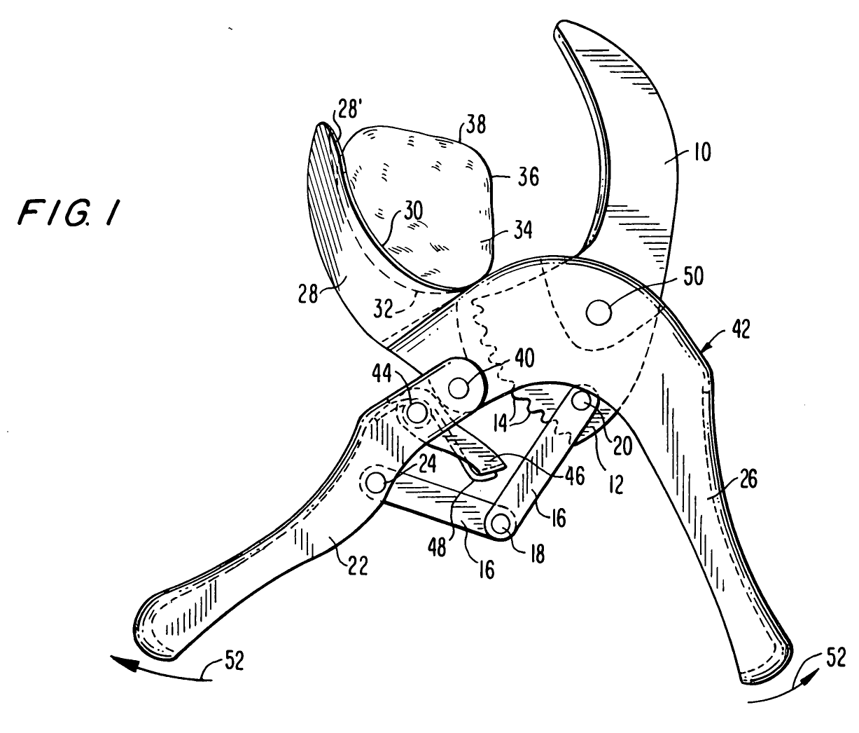

Referring to the drawings, FIG. 1 shows the shellfish opener device as including knife arm 10, having a ratchet wheel 12 at the base thereof, the ratchet wheel 12 defining a row of teeth 14, A pair of connecting bars 16 are riveted together at 18, with one connecting arm also being riveted at point 20 to the ratchet wheel 12. The other connecting arm is riveted to first squeeze handle 22, the rivet being at point 24. Second squeeze handle 26 is unitary with holding arm 28, which defines at its inner edge 28′ groove 30, which is bottomless and of a size comfortably to restrain the rounded front 32 of clam 34.

Clam 34 also has a hinge point 36 at the back 38 of clam 34.

First squeeze handle 22 is rotatably riveted at point 40 to the unitary holding arm-second squeeze handle combination, generally designated 42. Furthermore, at point 44 in first squeeze handle 22, a rivet rotatably holds pawl 46, which is spring-loaded toward ratchet wheel 12, by spring 48.

Knife arm 10 is attached to the combination structure 42, by either a bolt and nut inserted at point 50, or with a tight-fitting rivet. Arrows 52 indicates, in FIG. 1, the spreading motion of the two squeeze handles, which places the knife arm 10 and the holding arm 28 in position for the start of the operation for separation of the clam shells by mounting the clam to the holding arem.

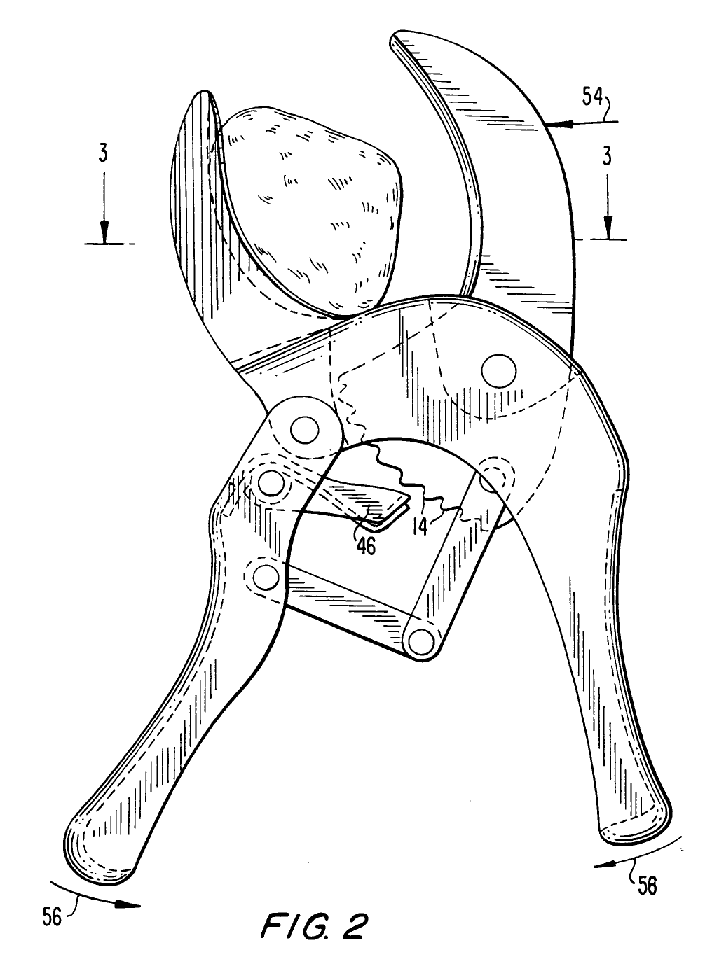

FIG. 2 is the same structure as shown in FIG. 1, but with the pawl ready for insertion near one end of the row of teeth 14 of the ratchet wheel, the clam 34 with its rounded front nearing full insertion to groove 30, defined by holding arm 28. At this point, the hinge point at the back of the clam faces the knife and is being lined up for separation at the hinge point when the knife arm 10 moves in a direction represented by arrow 54, such motion caused by repetitive squeezing handles of 22, 26 in directions represented by arrows 56 (squeezing the squeeze handles toward each other).

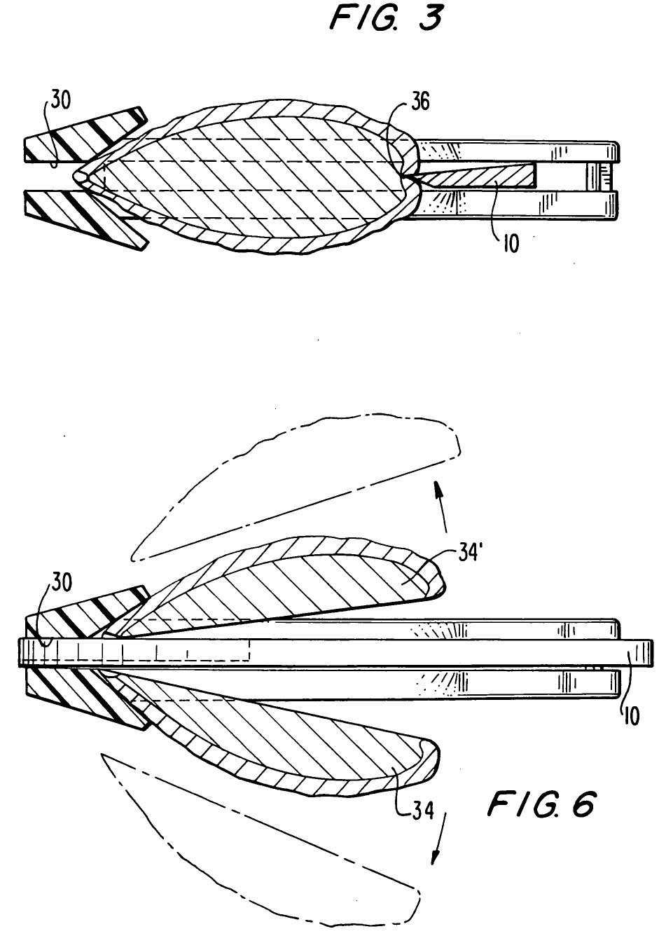

FIG. 3 shows particularly the groove 30 defined by the holding arm 28 with knife arm 10 ready for insertion at hinge point 36 of clam 34.

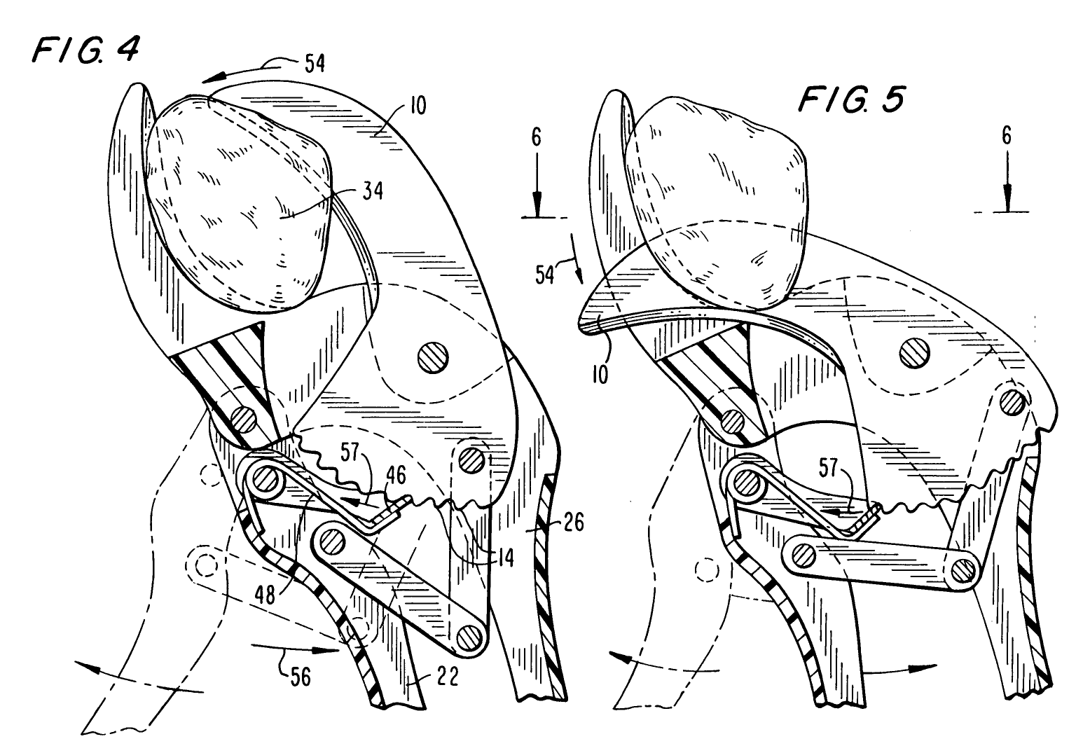

FIG. 4 shows knife arm 10, having moved in the direction represented by arrows 54, with its insertion to clam 34 in progress, as caused by the repetitive squeezing of squeeze handles 22, 26, which causes pawl 46 to move in the direction represented by arrow 57. Such motion by pawl 46, under control of spring 48, causes pawl 46 to move to near the other end of the row of teeth, furthest from where it started by the spreading of the squeeze handles. In other words, in the orientation of FIG. 4, pawl 46 started the operation near the right end of the row of teeth 14, and at the point of the operation shown in FIG. 4, has moved leftwardly toward the other end of the row of teeth (in direction 57).

FIG. 5 shows the knife arm 10 fully inserted through the clam and into the bottomless groove 30 of holding arm 28.

FIG. 6 shows the completion of the operation, with the clam shells 34 and 34′ split open, and knife 10 fully inserted through groove 30.

1. A scissor-like device for opening mollusk shells, each defining a rounded front shell portion and a hinge point back portion, comprising in combination:
(a) a knife arm including a knife and a ratchet wheel at the base of the knife, defining a row of ratchet teeth;
(b) a first squeeze handle connected to said ratchet wheel by a foldable pair of connecting bars;
(c) a pawl rotatably connected to said first squeeze handle and positioned for engagement with said ratchet teeth;
(d) a combination holding arm and second squeeze handle, said holding arm in a position opposed to said knife, said holding arm defining a bottomless groove in position for receiving said knife, said first squeeze handle rotatably connected to the base of said holding arm, and said foldable pair of connecting bars also rotatably connected to said ratchet wheel; and
(e) said bottomless groove being of a size and structure to receive insertion of said rounded front shell portion of said mollusk in said groove, whose shells are separated by repetitive squeezing of said squeeze handles.

2. The device of claim 1, wherein said pawl is inserted proximate one end of said row of ratchet teeth at the time when said mollusk is placed in said groove, and said repetitive squeezing moves said pawl to proximate the other end of said row of ratchet teeth.

3. The device of claim 1, wherein said foldable pair of connecting bars are shaped and connected to fold together when said first and second squeeze handles are moved toward each other.
